(19) United States
(12) Patent Application Publication
(10) Pub. No.: US 2026/0302345 A1
(43) Pub. Date: Oct. 1, 2026

(54) LITHIUM-ION SOLID-STATE SECONDARY BATTERY

(71) Applicant: HONDA MOTOR CO., LTD., Tokyo (JP)

(72) Inventors: Takuya TANIUCHI, Saitama (JP); Masahiro HOKAZONO, Saitama (JP); Kizashi IWAKIRI, Saitama (JP); Kiyoshi TANAAMI, Saitama (JP); Toshimitsu TANAKA, Saitama (JP); Tomohiko TSUZAKI, Saitama (JP)

(21) Appl. No.: 19/578,879

(22) Filed: Mar. 26, 2026

(30) Foreign Application Priority Data
Mar. 31, 2025 (JP) 2025-060134

(51) Int. Cl. H01M 10/0562; H01M 10/0525; H01M 10/0585

(52) U.S. Cl. CPC H01M 10/0562; H01M 10/0525; H01M 10/0585; H01M 2300/0068; H01M 2300/0094

(57) ABSTRACT

A lithium-ion solid-state secondary battery according to one embodiment of the present invention includes a positive electrode layer, a negative electrode layer, and a solid electrolyte layer interposed between the positive electrode layer and the negative electrode layer, wherein the solid electrolyte layer has a two-layer structure in which a first solid electrolyte layer disposed on a positive electrode layer side and a second solid electrolyte layer disposed on a negative electrode layer side are laminated.

This application is based on and claims the benefit of priority from Japanese Patent Application No. 2025-060134, filed on 31 Mar. 2025, the content of which is incorporated herein by reference.

### BACKGROUND OF THE INVENTION

### Field of the Invention

The present invention relates to a lithium-ion solid-state secondary battery.

### Related Art

In recent years, research and development that pertain to secondary batteries, which contribute to the enhancement of energy efficiency, has been carried out in order to ensure that more people have access to reliable, sustainable, and advanced energy at reasonable cost.

As such a secondary battery, a lithium-ion solid-state secondary battery is known in which: lithium ions are used as charge transfer media; and a solid electrolyte layer is disposed between a positive electrode layer and a negative electrode layer. Lithium-ion solid-state secondary batteries have been examined regarding the provision of a solid electrolyte layer in the form of a laminate having a two-layer structure in which a first solid electrolyte layer disposed on the positive electrode layer side and a second solid electrolyte layer disposed on the negative electrode layer side are laminated. For example, examinations have been made to establish: the maximum height Rz1 of the surface (first surface) of a first solid electrolyte layer on the second solid electrolyte layer side and the maximum height Rz2 of the surface (second surface) of the second solid electrolyte layer on the first solid electrolyte layer side have a prescribed relationship therebetween (Patent Document 1); a first solid electrolyte layer has a higher density than a second solid electrolyte layer (Patent Document 2); and sulfide-based solid electrolytes are used as the solid electrolytes, and the median particle size (D50) of a second sulfide-based solid electrolyte contained in a second solid electrolyte layer is larger than the median particle size (D50) of a first sulfide-based solid electrolyte contained in a first solid electrolyte layer (Patent Document 3).
Patent Document 1: Japanese Unexamined Patent Application, Publication No. 2023-009988
Patent Document 2: PCT International Publication No. WO2024/111841
Patent Document 3: Japanese Unexamined Patent Application (Translation of PCT Application), Publication No. 2023-524296

### SUMMARY OF THE INVENTION

In the meantime, the solid electrolyte layer of a lithium-ion solid-state secondary battery needs to have a plurality of functions such as a function of separating a positive electrode layer and a negative electrode layer from each other, a function of preventing precipitation of lithium metal, an ion conducting function, a volume-expansion reducing function, and a cushioning function. The solid electrolyte layer also needs to have high characteristics of contributing to structure feasibility in, for example, strength and toughness. According to examinations carried out by the inventors, however, it will be difficult for a solid electrolyte layer having a single-layer structure to satisfy the noted functions and characteristics. It will also be difficult to satisfy the functions and characteristics by using the conventional solid electrolyte layer having a two-layer structure.

The present invention was arrived at in view of the situation described above, and an object thereof is to provide a lithium-ion solid-state secondary battery of which the battery cell performance for shorting prevention/durability improvement and the structure feasibility in strength/toughness have been improved at a high level in a balanced fashion. The present invention ultimately contributes to the improvement of energy efficiency.

In view of the problem described above, the inventors have found that it is effective to make it so that a solid electrolyte layer is a laminate in which a first solid electrolyte layer disposed on the positive electrode layer side and a second solid electrolyte layer disposed on the negative electrode layer side are laminated and so that the mass content of the solid electrolyte layer of the first solid electrolyte layer is higher than the mass content of the solid electrolyte of the second solid electrolyte layer, thereby completing the present invention. Accordingly, the present invention provides the following.

(1) According to a first aspect, a lithium-ion solid-state secondary battery includes a positive electrode layer, a negative electrode layer, and a solid electrolyte layer interposed between the positive electrode layer and the negative electrode layer, wherein the solid electrolyte layer is a laminate in which a first solid electrolyte layer disposed on a positive electrode layer side and a second solid electrolyte layer disposed on a negative electrode layer side are laminated, the first solid electrolyte layer includes a first solid electrolyte, and the second solid electrolyte layer includes a second solid electrolyte, D50_2/D50_1, which is a ratio of a median particle size D50_2 of the second solid electrolyte to a median particle size D50_1 of the first solid electrolyte, falls within a range from 1.0 to 50.0 inclusive, and W1/W2, which is a ratio of a mass content W1 of the first solid electrolyte in the first solid electrolyte layer to a mass content W2 of the second solid electrolyte in the second solid electrolyte layer, falls within a range from more than 1.0 to 1.2 or less.

According to the lithium-ion solid-state secondary battery according to aspect (1), the first solid electrolyte layer has a higher mass content of solid electrolyte than the second solid electrolyte layer, and the components of the first solid electrolyte are brought into close contact with each other with high adhesion, so the first solid electrolyte layer serves as a hard layer that has high lithium ion conductivity and high rigidity and is excellent in shape stability. Meanwhile, the second solid electrolyte layer can have a higher mass content of non-solid-electrolyte components (e.g., binder) than the first solid electrolyte layer, and thus achieves high flexibility and ductility and can be easily brought into close contact with the first solid electrolyte layer and the negative electrode layer with the shock resistance enhanced, thereby serving as a soft layer that is excellent in the relaxation performance for a strain imposed on the second solid electrolyte layer. Thus, the solid electrolyte layer in which the first and second solid electrolyte layers are laminated is excellent in lithium ion conductivity between the positive electrode layer and the negative electrode layer and also excellent in shape stability and toughness. Accordingly, the lithium-ion solid-state secondary battery according to aspect (1) improves the battery cell performance for discharge characteristics and cycle characteristics and the structure feasibility in shape stability and toughness at a high level in a balanced fashion.

(2) According to a second aspect, in the lithium-ion solid-state secondary battery according to aspect (1), the ratio D50_2/D50_1 falls within a range from 2.0 to 10.0 inclusive.

According to the lithium-ion solid-state secondary battery according to aspect (2), the components of the first solid electrolyte are finer than the components of the second solid electrolyte, resulting in a larger contact area between the components of the first solid electrolyte. This leads to higher lithium ion conductivity and higher rigidity and improvement in the shape stability. Meanwhile, the second solid electrolyte has coarser components than the first solid electrolyte, resulting in the components of the second solid electrolyte having larger gaps therebetween. Thus, the second solid electrolyte achieves higher flexibility and ductility and can be more easily brought into close contact with the first solid electrolyte layer and the negative electrode layer while achieving higher shock resistance, thereby improving the relaxation performance for a strain imposed on the second solid electrolyte layer. Accordingly, the lithium-ion solid-state secondary battery according to aspect (2) improves the battery cell performance and the structure feasibility at a higher level in a balanced fashion.

(3) According to a third aspect, in the lithium-ion solid-state secondary battery according to aspect (1) or (2), the median particle size D50_1 of the first solid electrolyte falls within a range from 0.1 μm or more to less than 1.0 μm, and the median particle size D50_2 of the second solid electrolyte falls within a range from 1.0 μm to 5.0 μm inclusive.

According to the lithium-ion solid-state secondary battery according to aspect (3), the median particle size D50_1 of the first solid electrolyte and the median particle size D50_2 of the second solid electrolyte fall within the noted ranges, so the first solid electrolyte layer has higher lithium ion conductivity, higher rigidity, and improved shape stability. The second solid electrolyte has higher flexibility and ductility and can be more easily brought into close contact with the first solid electrolyte layer and the negative electrode layer while achieving higher shock resistance, thereby further improving the relaxation performance for a strain imposed on the second solid electrolyte layer. Accordingly, the lithium-ion solid-state secondary battery according to aspect (3) improves the battery cell performance and the structure feasibility at a higher level in a balanced fashion.

(4) According to a fourth aspect, in the lithium-ion solid-state secondary battery according to any one of aspects (1) to (3), a particle size D10_1 of the first solid electrolyte is less than 1.0 μm, and a particle size D90_2 of the second solid electrolyte is 5.0 μm or more.

According to the lithium-ion solid-state secondary battery according to aspect (4), the first solid electrolyte layer contains a multitude of fine solid electrolyte components, so that gaps in the first solid electrolyte layer are filled by solid electrolyte components, thereby making the gaps finer. Hence, the first solid electrolyte layer has further improved lithium ion conductivity. The second solid electrolyte layer contains a multitude of coarse solid electrolyte components. Coarse solid electrolyte components have a small specific surface area, so the second solid electrolyte layer includes coarser gaps than the first solid electrolyte layer. Hence, the second solid electrolyte layer has higher shock resistance, thereby further improving the relaxation performance for a strain imposed on the second solid electrolyte layer. Accordingly, the lithium-ion solid-state secondary battery according to aspect (4) improves the battery cell performance and the structure feasibility at a higher level in a balanced fashion.

(5) According to a fifth aspect, in the lithium-ion solid-state secondary battery according to any one of aspects (1) to (4), S1/S2, which is a ratio of a specific surface area S1 of the first solid electrolyte to a specific surface area S2 of the second solid electrolyte, falls within a range from 1.0 to 30.0 inclusive.

According to the lithium-ion solid-state secondary battery according to aspect (5), the first solid electrolyte has a larger specific surface area than the second solid electrolyte and contains a multitude of fine solid electrolyte components, so the first solid electrolyte layer includes fine gaps, thereby further improving the lithium ion conductivity. The second solid electrolyte layer contains a multitude of coarse solid electrolyte components. Thus, the second solid electrolyte layer includes coarser gaps than the first solid electrolyte layer, thereby further improving the relaxation performance for a strain imposed on the second solid electrolyte layer. Accordingly, the lithium-ion solid-state secondary battery according to aspect (5) improves the battery cell performance and the structure feasibility at a higher level in a balanced fashion.

(6) According to a sixth aspect, in the lithium-ion solid-state secondary battery according to any one of aspects (1) to (5), a porosity P1 of the first solid electrolyte layer is less than 1%, and a porosity P2 of the second solid electrolyte layer is 1% or more.

According to the lithium-ion solid-state secondary battery according to aspect (6), the first solid electrolyte layer includes fewer gaps than the second solid electrolyte layer, so the first solid electrolyte layer has higher lithium ion conductivity, higher rigidity, and improved shape stability. The second solid electrolyte includes more gaps than the first solid electrolyte layer and thus has higher flexibility and ductility and can be more easily brought into close contact with the first solid electrolyte layer and the negative electrode layer while achieving higher shock resistance, thereby further improving the relaxation performance for a strain imposed on the second solid electrolyte layer. Accordingly, the lithium-ion solid-state secondary battery according to aspect (6) improves the battery cell performance and the structure feasibility at a higher level in a balanced fashion.

(7) According to a seventh aspect, the lithium-ion solid-state secondary battery according to any one of aspects (1) to (6) further includes an intermediate layer between the solid electrolyte layer and the negative electrode layer.

In the lithium-ion solid-state secondary battery according to aspect (7), the interface between the negative electrode layer and the second solid electrolyte layer is stabilized, thereby improving the battery cell performance.

The present invention makes it possible to provide a lithium-ion solid-state secondary battery of which the battery cell performance for shorting prevention/durability improvement and the structure feasibility in strength/toughness have been improved at a high level in a balanced fashion.

### BRIEF DESCRIPTION OF THE DRAWINGS

FIG. 1 is a plan view of a lithium-ion solid-state secondary battery according to one embodiment of the present invention;

FIG. 2 is a II-II line cross-sectional view of FIG. 1; and

FIG. 3 is a III-III line cross-sectional view of FIG. 1.

### DETAILED DESCRIPTION OF THE INVENTION

The following describes embodiments of the present invention by referring to the drawings. However, the embodiments hereinafter exemplify the present invention, and the present invention is not limited to the embodiments hereinafter.

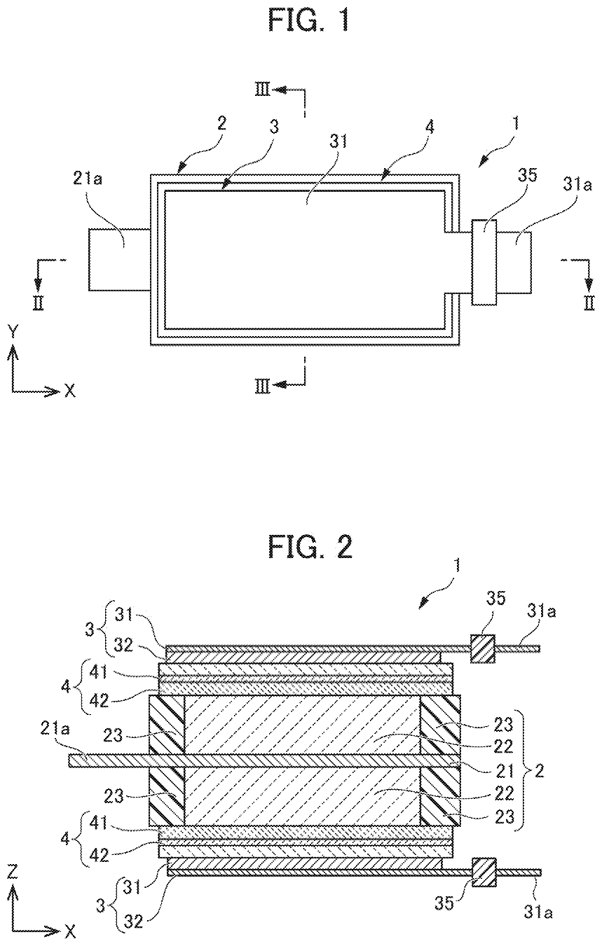

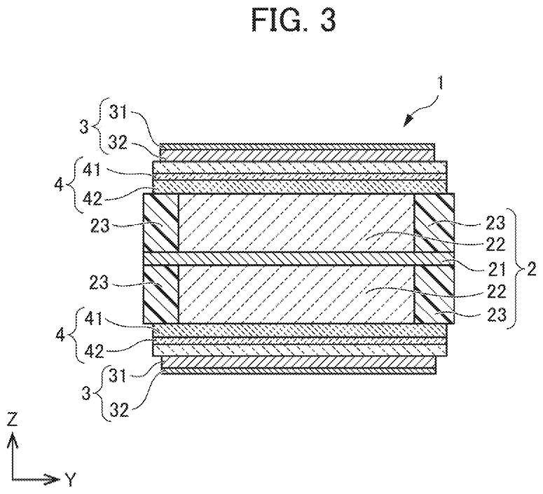

FIG. 1 is a plan view of a lithium-ion solid-state secondary battery according to one embodiment of the present invention. FIG. 2 is a II-II line cross-sectional view of FIG. 1. FIG. 3 is a III-III line cross-sectional view of FIG. 1.

As depicted in FIGS. 1 to 3, the lithium-ion solid-state secondary battery 1 includes a positive electrode layer 2, a negative electrode layer 3, and a solid electrolyte layer 4 interposed between the positive electrode layer 2 and the negative electrode layer 3.

The positive electrode layer 2 has a positive-electrode current collector 21, positive-electrode active material layers 22, and insulating members 23. The positive-electrode active material layers 22 are disposed on the respective surfaces of the positive-electrode current collector 21. The insulating members 23 are disposed on the respective surfaces of the positive-electrode current collector 21 and surround the positive-electrode active material layers 22. The positive-electrode current collector 21 is connected to a positive electrode tab 21a. The positive electrode tab 21a extends in one direction (X direction in FIG. 1). For example, the thickness of the positive-electrode current collector 21 may fall within a range from 0.1 μm to 1 mm inclusive. For example, the thicknesses of the positive-electrode active material layers 22 and the insulating members 23 may fall within a range from 0.1 μm to 1 mm inclusive.

Examples of the material for the positive-electrode current collector 21 include aluminum, aluminum alloys, stainless steel, nickel, iron, and titanium.

The positive-electrode active material layer 22 contains a positive-electrode active material. The positive-electrode active material may be a lithium compound that releases lithium ions while the lithium-ion solid-state secondary battery 1 is charged and occludes lithium ions while the lithium-ion solid-state secondary battery 1 is discharged. For example, a layered active material, a spinel-type active material, or an olivine-type active material may be used as the lithium compound. Specific examples of the positive-electrode active material include, for example, lithium cobalt oxide (LiCoO₂), lithium nickelate (LiNiO₂), lithium nickel manganese cobalt oxide (NMC: LiNiₚMn_{q}CoᵣO₂ (p+q+r=1)), LiNiₚAl_{q}CoᵣO₂ (p+q+r=1), lithium manganate oxide (LiMn₂O₄), a dissimilar element-substituted Li—Mn spinel represented by Li₁₊ₓMn_{2-x-y}MO₄ (x+y=2, M is at least one type selected from Al, Mg, Co, Fe, Ni, or Zn), lithium titanate (oxide containing Li and Ti), lithium metal phosphate (LiMPO₄, M is at least one type selected from Fe, Mn, Co, or Ni). The positive-electrode active material layer 22 may further include materials that may be contained in a positive-electrode active material layer for a lithium-ion solid-state secondary battery, e.g., electric conduction aid, binder, solid electrolyte.

Examples of the material for the positive electrode tab 21a include aluminum, aluminum alloys, stainless steel, nickel, iron, and titanium. The positive electrode tab 21a may be integral with the positive-electrode current collector 21.

Examples of the material for the insulating member 23 include, for example, insulating oxides such as alumina, resins such as polyvinylidene fluoride (PVDF), and rubbers such as styrene-butadiene rubber (SBR).

The negative electrode layer 3 includes a negative-electrode current collector 31 and a negative-electrode active material layer 32. The negative-electrode current collector 31 is connected to a negative electrode tab 31a. The negative electrode tab 31a extends in the opposite direction from the positive electrode tab 21a (X direction in FIG. 1). Insulating tape 35 is disposed on a portion of the negative electrode tab 31a. The insulating tape 35 insulates the negative electrode tab 31a such that the negative electrode tab 31a is not brought into contact with the positive-electrode current collector 21 when the negative electrode tab 31a is bent toward the positive electrode layer 2. For example, the thickness of the negative-electrode current collector 31 may fall within a range from 0.1 μm to 1 mm inclusive. For example, the thickness of the negative-electrode active material layer 32 may fall within a range from 0.1 μm to 1 mm inclusive.

Examples of the material for the negative-electrode current collector 31 include copper, copper alloys, nickel, and stainless steel.

The negative-electrode active material layer 32 may be a substance that occludes lithium ions or precipitates the same in the form of lithium metal or a lithium alloy while the lithium-ion solid-state secondary battery 1 is charged, and releases lithium ions while the lithium-ion solid-state secondary battery 1 is discharged. Lithium may be used as a substance that precipitates lithium ions in the form of lithium metal during charging. A metal that forms an alloy with lithium or an alloy that contains said metal may be used as a substance that occludes lithium ions during charging. Examples of metals that form an alloy with lithium include Mg, Zn, Al, In, Si, Ge, Sn, Ag, Au, Pt, Pd, Pb, Sb, and Bi. Otherwise, the substance that occludes lithium ions during charging may be a lithium transition metal oxide such as lithium titanate (Li₄Ti₅O₁₂), a transition metal oxide such as TiO₂, Nb₂O₃, or WO₃, a metal sulfide, a metal nitride, graphite, or a carbon material such as soft carbon or hard carbon. The negative-electrode active material layer 32 may further include materials that may be contained in a negative-electrode active material layer for a lithium-ion solid-state secondary battery, e.g., electric conduction aid, binder, solid electrolyte. Meanwhile, the negative-electrode active material layer 32 may be not provided, and lithium ions may be precipitated in the form of lithium metal directly on the negative-electrode current collector 31.

Examples of the material for the negative electrode tab 31a include copper, copper alloys, nickel, and stainless steel. The negative electrode tab 31a may be integral with the negative-electrode current collector 31.

The solid electrolyte layer 4 is a two-layer structure in which a first solid electrolyte layer 41 disposed on the positive electrode layer 2 side and a second solid electrolyte layer 42 disposed on the negative electrode layer 3 side are laminated. The first solid electrolyte layer 41 includes a first solid electrolyte. The second solid electrolyte layer 42 includes a second solid electrolyte.

D50_2/D50_1, which is the ratio of a median particle size D50_2 of the second solid electrolyte to a median particle size D50_1 of the first solid electrolyte, falls within a range from 1.0 to 10 inclusive. The median particle size D50 is a particle size of which the cumulative value is 50% on a cumulative volume particle undersize distribution curve.

The ratio D50_2/D50_1 may be higher than 1.0 but not higher than 10. In a case where the ratio D50_2/D50_1 is higher than 1.0, the first solid electrolyte is finer than the second solid electrolyte and has a large specific surface area, so components of the first solid electrolyte are easily brought into close contact with each other. Hence, the first solid electrolyte layer 41 has relatively high lithium ion conductivity and improved strength in comparison with the second solid electrolyte. Owing to the high lithium ion conductivity, lithium ions are unlikely to be precipitated in the first solid electrolyte layer 41, and shorting is unlikely to occur in the solid electrolyte layer 4. Meanwhile, the second solid electrolyte is coarser than the first solid electrolyte, and components of the second solid electrolyte have larger gaps therebetween. As a result, the second solid electrolyte layer 42 is relatively easily deformed and has improved toughness in comparison with the first solid electrolyte layer 41. Owing to the second solid electrolyte layer 42 being easily deformed, the second solid electrolyte layer 42 has an enhanced volume-expansion reducing function and cushioning function. In order to improve the lithium ion conductivity of the first solid electrolyte layer 41 and the deformability of the second solid electrolyte layer 42, the ratio D50_2/D50_1 may fall within, for example, a range from 2.0 to 5.0 inclusive.

For example, the median particle size D50_1 of the first solid electrolyte may be at least 0.1 μm and less than 1.0 μm. For example, the median particle size D50_2 of the second solid electrolyte may fall within a range from 2.0 μm to 5.0 μm inclusive.

The particle size D10_1 of the first solid electrolyte may be less than 0.5 μm. The particle size D10 is a particle size of which the cumulative value is 10% on a cumulative volume particle undersize distribution curve. The particle size D10 being a low value means that the proportion of fine particles is high. A high proportion of fine particles provides an increased specific surface area and thus achieves high adhesion. The particle size D10_1 of the first solid electrolyte is preferably small in order to improve the lithium ion conductivity and the strength of the first solid electrolyte layer 41. For example, the particle size D10_1 of the first solid electrolyte may fall within a range from 0.01 μm to 0.4 μm inclusive. For example, D10_1/D50_1, which is the ratio of the particle size D10_1 of the first solid electrolyte to the median particle size D50_1 thereof, may fall within a range from 0.1 to 0.7 inclusive.

The particle size D90_2 of the second solid electrolyte may be 5.0 μm or greater. The particle size D90 is a particle size of which the cumulative value is 90% on a cumulative volume particle undersize distribution curve. The particle size D90 being a high value means that the proportion of coarse particles is high. As the proportion of coarse particles increases, gaps between components of the solid electrolyte become larger, resulting in reduced adhesion. The particle size D90_2 of the second solid electrolyte is preferably large in order to improve the deformability and the toughness of the second solid electrolyte layer 42. For example, the particle size D90_2 of the second solid electrolyte may fall within a range from 5.0 μm to 15 μm inclusive. For example, D90_2/D50_2, which is the ratio of the particle size D90_2 of the second solid electrolyte to the median particle size D50_2 thereof, may fall within a range from 2.0 to 5.0 inclusive.

The values of the particle size distributions of the first and second solid electrolytes are measured using a laser diffraction/scattering method.

For example, S1/S2, which is the ratio of the specific surface area S1 of the first solid electrolyte to the specific surface area S2 of the second solid electrolyte, may fall within a range from 1.0 to 30.0 inclusive. For example, the specific surface area S1 of the first solid electrolyte may fall within a range from 10 m²/g to 30 m²/g inclusive, or may fall within a range from 2.0 m²/g to 4.0 m²/g inclusive. For example, the specific surface area S2 of the second solid electrolyte may fall within a range from 1 m²/g to 10 m²/g inclusive. The values of the specific surface areas of the first and second solid electrolytes are measured using the BET method with nitrogen gas.

For example, T2/T1, which is the ratio of the thickness T1 of the first solid electrolyte layer 41 to the thickness T2 of the second solid electrolyte layer 42, is preferably higher than 1 but not higher than 100. For example, the thickness T1 of the first solid electrolyte layer 41 may fall within a range from 1 μm to 10 μm inclusive. The thickness T1 of the first solid electrolyte layer 41 falling within this range improves the lithium ion conductivity of the solid electrolyte layer 4. For example, the thickness T2 of the second solid electrolyte layer 42 may fall within a range from 10 μm to 100 μm inclusive. The thickness T2 of the second solid electrolyte layer 42 falling within this range improves the shape stability and the toughness of the solid electrolyte layer 4.

For example, P1/P2, which is the ratio of the porosity P1 of the first solid electrolyte layer 41 to the porosity P2 of the second solid electrolyte layer 42, may be less than 1, or may fall within a range from 0.1 to 0.9 inclusive. For example, the porosity P1 of the first solid electrolyte layer 41 may be lower than 1%, or may fall within a range from 0.1% to 0.99% inclusive. For example, the porosity P2 of the second solid electrolyte layer 42 may be 1% or higher, or may fall within a range from 2% to 5% inclusive.

The first solid electrolyte layer 41 and the second solid electrolyte layer 42 may further include a material that may be contained in a solid electrolyte layer for a lithium-ion solid-state secondary battery, e.g., binder.

W1/W2, which is the ratio of the mass content W1 of the first solid electrolyte in the first solid electrolyte layer 41 to the mass content W2 of the second solid electrolyte in the second solid electrolyte layer 42, is higher than 1.0 but not higher than 1.2. For example, the mass content W1 of the first solid electrolyte may be 97 mass % or higher. The mass content W1 of the first solid electrolyte is lower than 100 mass %, and may be 99.9 mass % or lower or may be 99.5 mass % or lower. For example, the mass content W2 of the second solid electrolyte may be 81 mass % or higher. The mass content W2 of the second solid electrolyte is lower than 100 mass %, and may be 99.9 mass %, may be 99.5 mass % or lower, or may be 98 mass % or lower.

In a case where the ratio W1/W2 is higher than 1.0, the first solid electrolyte layer 41 has a higher solid electrolyte content than the second solid electrolyte layer, so the components of the solid electrolyte of the first solid electrolyte layer 41 are brought into close contact with each other more easily than the components of the solid electrolyte of the second solid electrolyte layer 42. Hence, the first solid electrolyte layer 41 has relatively high lithium ion conductivity and improved strength in comparison with the second solid electrolyte. Owing to the high lithium ion conductivity, lithium ions are unlikely to be precipitated in the first solid electrolyte layer 41, and shorting is unlikely to occur in the solid electrolyte layer 4. Meanwhile, the second solid electrolyte layer contains a greater amount of non-solid-electrolyte materials (binder) than the first solid electrolyte layer 41. Thus, the second solid electrolyte layer 42 is relatively easily deformed and has improved toughness in comparison with the first solid electrolyte layer 41. Owing to the second solid electrolyte layer 42 being easily deformed, the second solid electrolyte layer 42 has an improved volume-expansion reducing function and cushioning function.

The materials for the first and second solid electrolytes are not particularly limited, as long as the same can be used as a solid electrolyte for a lithium-ion solid-state secondary battery. The materials may be, for example, an inorganic solid electrolyte such as a sulfide solid electrolyte material, an oxide solid electrolyte material, a halide solid electrolyte, or a lithium-containing salt, or a polymeric solid electrolyte such as polyethylene oxide. The first and second solid electrolytes may be the same or different in material. One type of material alone or a combination of two or more types of materials may be used as the solid electrolytes.

The binder may be, for example, a fluorine-based polymer, a nitrile-based polymer, a polyester-based polymer, an acrylic acid-based polymer, a cellulose-based polymer, a styrene-based polymer, a styrene-butadiene-based polymer, a vinyl acetate-based polymer, a urethane-based polymer, or a fluoroethylene-based polymer. Among these binders, a fluorine-based polymer is preferable. An example of the fluorine-based polymer may be, for example, polyvinylidene fluoride (PVDF).

For example, a method for manufacturing the lithium-ion solid-state secondary battery 1 may be one that includes laminating the solid electrolyte layer 4 and the negative electrode layer 3 in this order on the surface of the positive electrode layer 2. A transfer method or an application method can be used as a method for laminating the solid electrolyte layer 4 on the positive electrode layer 2. In the transfer method, a transfer sheet formed by laminating a to-be-transferred object on a support sheet is prepared, a transfer-target object and the to-be-transferred object of the transfer sheet are bonded together using a pressing method, and then the support sheet is stripped off. For example, a structure formed by laminating the second solid electrolyte layer 42 and the first solid electrolyte layer 41 in this order on the support sheet may be prepared as a solid electrolyte layer transfer sheet, and the positive electrode layer 2 and the first solid electrolyte layer 41 of the solid electrolyte layer transfer sheet may be bonded together. Alternatively, a laminate formed by transferring the first solid electrolyte layer 41 to the positive electrode layer 2 and a laminate formed by transferring the second solid electrolyte layer 42 to the negative electrode layer 3 may be prepared and laminated by press-bonding, thereby producing the lithium-ion solid-state secondary battery 1. In the application method, an application liquid containing a to-be-applied object is applied to an application-target object, and the resultant coating film is dried. A first application liquid containing a first solid electrolyte layer material and a second application liquid containing a second solid electrolyte layer material may be prepared as solid electrolyte layer forming application liquids, the first solid electrolyte layer 41 may be formed by applying the first application liquid to the positive electrode layer 2, and then the second solid electrolyte layer 42 may be formed by applying the second application liquid to the first solid electrolyte layer 41. Alternatively, a laminate formed by applying the first solid electrolyte layer 41 to the positive electrode layer 2 and a laminate formed by applying the second solid electrolyte layer 42 to the negative electrode layer 3 may be prepared and laminated by press-bonding, thereby producing the lithium-ion solid-state secondary battery 1.

A method for manufacturing the lithium-ion solid-state secondary battery 1 may also be one that includes laminating the solid electrolyte layer 4 and the positive electrode layer 2 in this order on the surface of the negative electrode layer 3. A transfer method or an application method can be used as a method for laminating the solid electrolyte layer 4 on the negative electrode layer 3. In the transfer method, a structure formed by laminating the first solid electrolyte layer 41 and the second solid electrolyte layer 42 in this order on a support sheet may be used as a solid electrolyte layer transfer sheet, and the negative electrode layer 3 and the second solid electrolyte layer 42 of the solid electrolyte layer transfer sheet may be bonded together. In the application method, the second solid electrolyte layer 42 may be formed by applying the second application liquid to the negative electrode layer 3, and then the first solid electrolyte layer 41 may be formed by applying the first application liquid to the second solid electrolyte layer 42. A pressing method can be used as a method for laminating the positive electrode layer 2 on the solid electrolyte layer 4.

A method for manufacturing the lithium-ion solid-state secondary battery 1 may also be one that includes laminating the solid electrolyte layer 4 and the negative electrode layer 3 in this order on the surface of the positive electrode layer 2. A transfer method or an application method can be used as a method for laminating the solid electrolyte layer 4 on the positive electrode layer 2. In the transfer method, a structure formed by laminating the first solid electrolyte layer 41 and the second solid electrolyte layer 42 in this order on a support sheet may be used as a solid electrolyte layer transfer sheet, and the positive electrode layer 2 and the first solid electrolyte layer 41 of the solid electrolyte layer transfer sheet may be transferred. In the application method, the first solid electrolyte layer 41 may be formed by applying the first application liquid to the positive electrode layer 2, and then the second solid electrolyte layer 42 may be formed by applying the second application liquid to the first solid electrolyte layer 41. A pressing method can be used as a method for laminating the negative electrode layer 3 on the solid electrolyte layer 4.

According to the lithium-ion solid-state secondary battery according to present embodiments, which has the configuration described above, the first solid electrolyte layer 41 has a higher mass content of solid electrolyte than the second solid electrolyte layer 42, and components of the first solid electrolyte are brought into close contact with each other with high adhesion, so the first solid electrolyte layer 41 has high lithium ion conductivity and improved strength. Meanwhile, the second solid electrolyte layer 42 can have a higher mass content of non-solid-electrolyte components (e.g., binder) than the first solid electrolyte layer 41, and thus can be easily deformed and has improved toughness. Accordingly, the lithium-ion solid-state secondary battery 1 according to present embodiments has battery cell performance for shorting prevention/durability improvement and structure feasibility in strength/toughness that have been improved at a higher level in a balanced fashion.

The lithium-ion solid-state secondary battery according to the present invention is not limited to the lithium-ion solid-state secondary battery 1 in the embodiments described above. For example, although the positive electrode layer 2, the solid electrolyte layer 4, and the negative electrode layer 3 are laminated in this order in the lithium-ion solid-state secondary battery 1 according to present embodiments, the structure of the lithium-ion solid-state secondary battery 1 is not limited to this. In the lithium-ion solid-state secondary battery 1 according to present embodiments, the second solid electrolyte layer 42 on the negative electrode layer 3 side is easily deformed, and the second solid electrolyte layer 42 and the negative electrode layer 3 can be brought into close contact with each other with high adhesion. An intermediate layer may be disposed in the lithium-ion solid-state secondary battery 1 in order to improve the battery cell performance for shorting prevention/durability improvement and the structure feasibility in strength/toughness at a higher level in a balanced fashion.

The intermediate layer may have a function for moving lithium ions uniformly over the entirety of the surface of the negative electrode layer 3 during charging. For example, the thickness of the intermediate layer 5 falls within a range from 0.3 μm to 10 μm inclusive.

For example, a substance for forming the intermediate layer may be, but is not particularly limited to, a metal that can be alloyed with lithium, amorphous carbon, or the like. The metal that can be alloyed with lithium may be, for example, Mg, Zn, Al, In, Si, Ge, Sn, Ag, Au, Pt, Pd, Pb, Sb, or Bi. The metal that can be alloyed with lithium may be nanoparticles. The amorphous carbon may be, for example, a carbon black such as acetylene black, furnace black, or ketjen black, coke, or activated carbon. The amorphous carbon may be a vapor grown carbon fiber (VGCF) or easily graphitizable carbon (soft carbon), or may be non-graphitizable carbon (hard carbon), a carbon nanotube (CNT), a fullerene, or graphene. Besides the noted substances, the intermediate layer may contain a binder.

The amorphous carbon may be easily graphitizable carbon (soft carbon), or may be non-graphitizable carbon (hard carbon). The amorphous carbon may be an allotrope of carbon that does not indicate a clear crystal state, or may be an aggregate of fine crystals of graphite. Specific examples of the amorphous carbon include, for example, carbon blacks such as acetylene black, furnace black, and ketjen black, coke, activated carbon, carbon nanotubes (CNTs), fullerenes, and graphene.

Particles of a metal that forms an alloy with lithium may be used as a metal to be contained in the intermediate layer. Examples of metals that form an alloy with lithium include Mg, Zn, Al, In, Si, Ge, Sn, Ag, Au, Pt, Pd, Pb, Sb, and Bi.

Besides the noted substances, the intermediate layer may contain a binder. The binder may be the binder used for the solid electrolyte layer 4. However, the intermediate layer and the solid electrolyte layer 4 may have the same binder used therefor or have different binders used therefor.

For example, the intermediate layer may be disposed using a method in which: the intermediate layer is laminated on the surface of the solid electrolyte layer 4; and then, the negative electrode layer 3 is laminated on the surface of the intermediate layer. A transfer method or an application method can be used as a method for laminating the intermediate layer 5 on the surface of the solid electrolyte layer 4. A pressing method can be used as a method for laminating the negative electrode layer 3 on the surface of the intermediate layer. A method for manufacturing the lithium-ion solid-state secondary battery in which the intermediate layer is disposed is not particularly limited. For example, the positive electrode layer 2, the solid electrolyte layer 4, the intermediate layer, and the negative electrode layer 3 may be prepared, and these layers may be laminated and bonded. The order in which the layers are bonded is not particularly limited. For example, a bonded body of the positive electrode layer 2 and the first solid electrolyte layer 41 and a bonded body of the second solid electrolyte layer 42, the intermediate layer, and the negative electrode layer 3 may be bonded together, or a bonded body of the positive electrode layer 2 and the solid electrolyte layer 4 and a bonded body of the intermediate layer and the negative electrode layer 3 may be bonded together.

### EXAMPLES

The following describes the present invention by referring to examples, but the present invention is not limited to these examples.

### Example 1

### (1) Production of Positive Electrode Layer

Aluminum foil having a thickness of 15 μm was prepared as a positive-electrode current collector. A positive-electrode active material was produced by mixing 80 parts by mass of lithium nickel cobalt manganese composite oxide (NCM 712), 17 parts by mass of argyrodite-based sulfide solid electrolyte as a solid electrolyte material, 2 parts by mass of carbon black as an electric conduction aid, and 1 part by mass of fluorine-based rubber binder as a binding agent. The obtained mixture was dispersed in 43 parts by mass of butyl butyrate so as to prepare positive-electrode active material layer slurry. The obtained positive-electrode active material layer slurry was applied to both surfaces of the positive-electrode current collector by using a bar coater such that the weight of coating would be 27 mg/cm² after drying, and the resultant structure was dried so as to form a positive-electrode active material layer having a thickness of 80 to 90 μm after pressing, thereby producing a positive electrode layer.

### (2) Production of Solid Electrolyte Layer Transfer Sheet

Two types of argyrodite-based sulfide solid electrolytes (first solid electrolyte, second solid electrolyte) were prepared as the solid electrolytes. The table 1 below indicates the particle size distributions, the tap densities, and the specific surface areas of the prepared solid electrolytes. The particle size distributions were measured using a laser diffraction/scattering method in compliance with JIS Z 8825: 2013. The tap densities were measured using a tapping device in compliance with JIS Z 2512: 2012. The specific surface areas were measured using the BET method with nitrogen gas in compliance with JIS Z 8830: 2013.

TABLE 1

| | | | | Tap | Specific |
|---|---|---|---|---|---|
| | Particle Size Distribution(μm) | | | Density | Surface Area |
| | D10 | D50 | D90 | (g/mL) | (m²/g) |
| First Solid | 0.4 | 0.7 | 2.5 | 0.5 | 13.3 |
| Electrolyte | | | | | |
| Second Solid | 1.3 | 3.2 | 9.9 | 0.6 | 5.0 |
| Electrolyte | | | | | |

97.00 parts by mass of second solid electrolyte and 3.00 parts by mass of SBR-based binder to serve as the binder were mixed. The obtained mixture was dispersed in a solvent so as to prepare second solid electrolyte slurry. The obtained second solid electrolyte slurry was applied to the surface of a support sheet and dried, thereby forming a second solid electrolyte layer containing 97.00 mass % of solid electrolyte.

98.70 parts by mass of first solid electrolyte and 1.30 parts by mass of SBR-based binder were mixed. The obtained mixture was dispersed in a solvent so as to prepare first solid electrolyte slurry. The obtained first solid electrolyte slurry was applied to the surface of the second solid electrolyte layer and dried, thereby forming a first solid electrolyte layer containing 98.70 mass % of solid electrolyte. In this way, a solid electrolyte layer transfer sheet having a two-layer structure was produced in which the second solid electrolyte layer and the first solid electrolyte layer are laminated in this order on the surface of the support sheet.

### (3) Production of Negative Electrode Layer

Copper foil having a thickness of 10 μm was prepared as a negative-electrode current collector. A negative electrode layer was produced by laminating metal lithium foil having a thickness of 6.5 μm on the surface of the copper foil.

### (4) Production of Lithium-Ion Solid-State Secondary Battery

The first solid electrolyte layer of the solid electrolyte layer transfer sheet was superposed on the surface of the positive-electrode active material layer of the positive electrode layer, and the resultant structures were bonded by using a roll press device under bonding conditions of a bonding pressure: 800 MPa and a bonding temperature: a room temperature. Then, the support sheet of the solid electrolyte layer transfer sheet was stripped off so as to provide a positive electrode layer/solid electrolyte layer bonded body. Afterward, the second solid electrolyte layer of the positive electrode layer/solid electrolyte layer bonded body was superposed on the surface of the negative-electrode active material layer of the negative electrode layer, the second solid electrolyte layer was transferred to the surface of the negative-electrode active material layer by using a roll press device at a bonding pressure of 200 MPa, and the resultant structures were bonded under a bonding condition of a bonding temperature: a room temperature. Then, the support sheet of the solid electrolyte layer transfer sheet was stripped off so as to provide a negative electrode layer/solid electrolyte layer bonded body. Next, the positive electrode layer and the negative electrode layer/solid electrolyte layer bonded body were bonded by using a uniaxial shape-forming press device at a bonding pressure of 120 MPa for one minute, and then a bonding pressure of 400 MPa was applied to the resultant structure by using a roll press device, thereby producing an electrode laminate. The obtained electrode laminate was placed in an aluminum laminate film outer packaging, thereby producing a lithium-ion solid-state secondary battery. A buffer material was disposed on the negative electrode layer side and the positive electrode layer side, and the structure was confined at a confining pressure of 3 MPa.

### Examples 2 to 4, Comparative Examples 1 to 3

The solid electrolyte layer transfer sheets indicated in table 1 were produced by varying the contents of the solid electrolytes in the first solid electrolyte slurry and second solid electrolyte slurry. Otherwise, lithium-ion solid-state secondary batteries were produced under the same conditions as example 1.

### [Evaluations]

The following evaluations were made using electrode laminates and lithium-ion solid-state secondary batteries obtained in examples 1 to 4 and comparative examples 1 to 3.

### (Thickness of Solid Electrolyte Layer, Porosity, and Presence/Absence of Fissures)

The lithium-ion solid-state secondary batteries obtained in examples 1 to 3 and comparative examples 1 to 3 were taken out from confining tools. The taken-out lithium-ion solid-state secondary batteries were each placed in a glove box and dissembled, and an electrode laminate was acquired. The acquired electrode laminate was cut, and a cut surface was subjected to surface processing using a CP processing machine and an FIB processing machine. The cut surface of the electrode laminate after the surface processing was observed using an SEM so as to acquire cross-section SEM images at magnifications of 1,000 to 2,500. On the basis of the acquired cross-section SEM images, the thickness and the porosity of the solid electrolyte layer were measured, and it was checked whether there was a fissure in the solid electrolyte layer. The measuring of the porosity and the checking of the presence/absence of a fissure were performed in the following manner. Table 2 indicates corresponding results together with the types and the solid electrolyte contents of the solid electrolytes of solid electrolyte layers.

The porosity was measured using ImageJ, which is image analysis software. The cross-section SEM images of the solid electrolyte layer were binarized using the image analysis software ImageJ and divided into gaps and other regions. The area of the gap portions was measured, and the percentage of the area of the gap portions with reference to the total area of the solid electrolyte layer in the observed cross-section images was defined as a porosity. In a case where a plurality of solid electrolyte layers were present, a porosity was measured for each of the solid electrolyte layers. The average value among 3 to 6 cross-section SEM images was defined as a porosity.

It was checked whether there was a fissure by visually checking the cross-section SEM images. An evaluation of “Absent” was given when there was no fissure, and an evaluation of “Present” was given when a fissure was seen. In a case where a plurality of solid electrolyte layers were present, an evaluation of “Present” was given when there was a fissure in one solid electrolyte layer.

### (Battery Performance of Lithium-Ion Solid-State Secondary Battery)

The lithium-ion solid-state secondary batteries obtained in examples 1 to 4 and comparative examples 1 to 2 were evaluated in terms of battery performance by using a charge/discharge device and an impedance measurement device. The states of the solid electrolyte layers of the lithium-ion solid-state secondary batteries after the evaluation were observed, and it was checked whether there was a loss. The lithium-ion solid-state secondary battery in comparative example 3, in which a fissure was seen in the solid electrolyte layer, was not evaluated in terms of battery performance. The values of initial voltages and DCR resistances achieved when discharging had been performed for 10 seconds were measured for the battery performance. It was judged that shorting had occurred when an initial voltage was 2.0 V or lower or when the value of a DCR resistance was 0Ω. Table 3 indicates the results.

(State of Solid Electrolyte Layer of Lithium-Ion Solid-State Secondary Battery after Evaluation)

The lithium-ion solid-state secondary batteries after the evaluation in battery performance were taken out from confining tools. The taken-out lithium-ion solid-state secondary batteries were each placed in a glove box and dissembled, and an electrode laminate was acquired. The acquired electrode laminate was cut, and a cut surface was subjected to processing using a CP processing machine and an FIB processing machine. Afterward, the cut surface of the electrode laminate was observed using an SEM so as to acquire cross-section SEM images at magnifications of 1,000 to 2,500, and it was checked whether there was a crack in the cross section of the solid electrolyte layer. For cross sections of solid electrolyte layers, an evaluation of “Good” was given when there was no crack, and an evaluation of “Poor” was given when there were one or more cracks having a length of 5 μm or greater. In a case where a plurality of solid electrolyte layers were present, an evaluation of “Poor” was given when there was a fissure in one solid electrolyte layer. Table 3 indicates the results.

### Capacity Retention Rate and Charge/Discharge Efficiency of Lithium-Ion Solid-State Secondary Battery

For the lithium-ion solid-state secondary battery obtained in example 1, a charge/discharge test was performed using a charge/discharge device under conditions of a current rate: 1/3 capacity rate and a voltage range: 3.7 to 4.0 V. The ratio of the discharge capacity after 300 cycles to the initial discharge capacity was calculated as a capacity retention rate. The ratio of the discharge capacity at 300 cycles to the charge capacity at 300 cycles was calculated as a charge/discharge efficiency. Table 3 indicates the results.

TABLE 2

| | Configuration of Solid Electrolyte Layer | | Evaluation of Solid Electrolyte | | |
|---|---|---|---|---|---|
| | Transfer Sheet | | Layer | | |
| | | Solid | | | Presence/ |
| | | Electrolyte | Thickness | | Absence |
| | Type of Solid Electrolyte Layer | Content (mass %) | (μm) | Voidage | of Fissure |
| Example 1 | First Solid Electrolyte Layer | 98.70 | 2.9 | Less than 1% | Absent |
| | (Positive Electrode Layer Side) | | | | |
| | Second Solid Electrolyte Layer | 97.00 | 106 | 1-3% | |
| | (Negative Electrode Layer Side) | | | | |
| Example 2 | First Solid Electrolyte Layer | 98.70 | 3 | Less than 1% | Absent |
| | (Positive Electrode Layer Side) | | | | |
| | Second Solid Electrolyte Layer | 82.50 | 40 | 3% or More | |
| | (Negative Electrode Layer Side) | | | | |
| Example 3 | First Solid Electrolyte Layer | 98.70 | 3 | Less than 1% | Absent |
| | (Positive Electrode Layer Side) | | | | |
| | Second Solid Electrolyte Layer | 94.50 | 100 | 1-3% | |
| | (Negative Electrode Layer Side) | | | | |
| Example 4 | First Solid Electrolyte Layer | 98.70 | 3 | Less than 1% | Absent |
| | (Positive Electrode Layer Side) | | | | |
| | Second Solid Electrolyte Layer | 90.95 | 40 | 1-3% | |
| | First Solid Electrolyte Layer | 98.70 | 3 | Less than 1% | |
| | (Negative Electrode Layer Side) | | | | |
| Example 5 | First Solid Electrolyte Layer | 90.95 | 40 | 1-3% | Absent |
| | (Positive Electrode Layer Side) | | | | |
| | Second Solid Electrolyte Layer | 98.70 | 3 | Less than 1% | |
| | (Negative Electrode Layer Side) | | | | |
| Comparative | First Solid Electrolyte Layer | 98.70 | 60 | Less than 1% | Absent |
| Example 1 | (Positive Electrode Layer Side) | | | | |
| | First Solid Electrolyte Layer | 98.70 | 10 | Less than 1% | |
| | (Negative Electrode Layer Side) | | | | |
| Comparative | Second Solid Electrolyte Layer | 97.00 | 10 | 1-3% | Absent |
| Example 2 | | | | | |
| Comparative | First Solid Electrolyte Layer | 98.70 | 60 | Less than 1% | Present |
| Example 3 | | | | | |

TABLE 3

| | Battery Performance Evaluation | | Cycle Test | |
|---|---|---|---|---|
| | DCR Resistance | Presence/Absence | Capacity Retention | Charge/Discharge |
| | Value (Ω) | of Crack | Rate (%) | Efficiency (%) |
| Example 1 | 11.0 | Good | 93 | 100 |
| Example 2 | 40.0 | Good | — | — |
| Example 3 | 23.7 | Good | — | — |
| Example 4 | 36.0 | Good | — | — |
| Example 5 | 36.0 | Good | — | — |
| Comparative | 15.0 | Poor | — | — |
| Example 1 | | | | |
| Comparative | 0 (Shorting) | — | — | — |
| Example 2 | | | | |
| Comparative | — | — | — | — |
| Example 3 | | | | |

It is found from the above-noted results that shorting does not occur in, but a low DCR resistance value is indicated by, the lithium-ion solid-state secondary batteries obtained in examples 1 to 4, in which W1/W2, i.e., the ratio of the mass content W1 of the first solid electrolyte of the first solid electrolyte layer to the mass content W2 of the second solid electrolyte of the second solid electrolyte layer, falls within the range specific to the present invention. It is found that the lithium-ion solid-state secondary battery obtained in example 1 has a charge/discharge efficiency of 100% after 300 cycles and exhibits high cycle characteristics. This is because a solid electrolyte layer in which first and second solid electrolyte layers are laminated and that achieves a ratio W1/W2 falling within the range specific to the present invention is excellent in the lithium ion conductivity between a positive electrode layer and a negative electrode layer and also excellent in shape stability and toughness.

By contrast, the lithium-ion solid-state secondary battery obtained in comparative example 3, in which the first solid electrolyte layer was used alone, had a fissure in the solid electrolyte layer immediately after the production. This is because using the first solid electrolyte alone leads to slight inferiority in toughness. Shorting occurred in the lithium-ion solid-state secondary battery obtained in comparative example 2, in which the second solid electrolyte layer was used alone. This is because using the second solid electrolyte alone leads to slight inferiority in rigidity and shape stability. The lithium-ion solid-state secondary battery obtained in comparative example 1, in which the ratio W1/W2 is 1, cracked after the DCR measurement was performed. This is because, when the solid electrolyte layer on the positive electrode layer side cracked due to a stress caused by, for example, lithium precipitation, the expansion of the crack into the solid electrolyte layer on the negative electrode layer side could not be suppressed, due to the solid electrolyte layer on the negative electrode layer side having a small difference in toughness and rigidity from the solid electrolyte layer on the positive electrode layer side.

### EXPLANATION OF REFERENCE NUMERALS

1: Lithium-ion solid-state secondary battery
2: Positive electrode layer
21: Positive-electrode current collector
21a: Positive electrode tab
22: Positive-electrode active material layer
23: Insulating member
3: Negative electrode layer
31: Negative-electrode current collector
31a: Negative electrode tab
32: Negative-electrode active material layer
35: Insulating tape
4: Solid electrolyte layer
41: First solid electrolyte layer
42: Second solid electrolyte layer

What is claimed is:

1. A lithium-ion solid-state secondary battery comprising a positive electrode layer, a negative electrode layer, and a solid electrolyte layer interposed between the positive electrode layer and the negative electrode layer, wherein
the solid electrolyte layer is a laminate in which a first solid electrolyte layer disposed on a positive electrode layer side and a second solid electrolyte layer disposed on a negative electrode layer side are laminated,
the first solid electrolyte layer includes a first solid electrolyte, and the second solid electrolyte layer includes a second solid electrolyte,
D50_2/D50_1, which is a ratio of a median particle size D50_2 of the second solid electrolyte to a median particle size D50_1 of the first solid electrolyte, falls within a range from 1.0 to 50.0 inclusive, and
W1/W2, which is a ratio of a mass content W1 of the first solid electrolyte in the first solid electrolyte layer to a mass content W2 of the second solid electrolyte in the second solid electrolyte layer, falls within a range from more than 1.0 to 1.2 or less.

2. The lithium-ion solid-state secondary battery according to claim 1, wherein the ratio D50_2/D50_1 falls within a range from 2.0 to 10.0 inclusive.

3. The lithium-ion solid-state secondary battery according to claim 1, wherein the median particle size D50_1 of the first solid electrolyte falls within a range from 0.1 μm or more to less than 1.0 μm, and the median particle size D50_2 of the second solid electrolyte falls within a range from 1.0 μm to 5.0 μm inclusive.

4. The lithium-ion solid-state secondary battery according to claim 1, wherein a particle size D10_1 of the first solid electrolyte is less than 1.0 μm, and a particle size D90_2 of the second solid electrolyte is 5.0 μm or more.

5. The lithium-ion solid-state secondary battery according to claim 1, wherein S1/S2, which is a ratio of a specific surface area S1 of the first solid electrolyte to a specific surface area S2 of the second solid electrolyte, falls within a range from 1.0 to 30.0 inclusive.

6. The lithium-ion solid-state secondary battery according to claim 1, wherein a porosity P1 of the first solid electrolyte layer is less than 1%, and a porosity P2 of the second solid electrolyte layer is 1% or more.

7. The lithium-ion solid-state secondary battery according to claim 1, wherein a thickness T1 of the first solid electrolyte layer is different from a thickness T2 of the second solid electrolyte layer.

8. The lithium-ion solid-state secondary battery according to claim 7, wherein T2/T1, which is a ratio of the thickness T1 of the first solid electrolyte layer to the thickness T2 of the second solid electrolyte layer, falls within a range from more than 1 to 100 or less.

9. The lithium-ion solid-state secondary battery according to claim 1, wherein the negative electrode layer contains lithium metal or a lithium alloy.
